(19) United States
(12) Patent Application Publication
(10) Pub. No.: US 2025/0149639 A1
(43) Pub. Date: May 8, 2025

(54) BATTERY ELECTRODE MANUFACTURING DEVICE AND BATTERY ELECTRODE MANUFACTURING METHOD

(71) Applicant: APB Corporation, Echizen-shi, Fukui (JP)

(72) Inventors: Hideaki HORIE, Echizen-shi, Fukui (JP); Kenichiro ENOKI, Kyoto-shi, Kyoto (JP); Yusuke NAKASHIMA, Kyoto-shi, Kyoto (JP); Kotaro NASU, Kyoto-shi, Kyoto (JP)

(21) Appl. No.: 18/836,755

(22) PCT Filed: Feb. 16, 2023
(86) PCT No.: PCT/JP2023/005526

§ 371 Date: Aug. 8, 2024

(30) Foreign Application Priority Data
Feb. 16, 2022 (JP) 2022-021951
Feb. 16, 2022 (JP) 2022-022039

(51) Int. Cl. H01M 10/058; H01M 4/04

(52) U.S. Cl. CPC H01M 10/058; H01M 4/0435

(57) ABSTRACT

A battery electrode manufacturing device (1000) comprises: a conveying part (1200) that conveys a strip-shaped base film; an electrode composition supply part (1300) that supplies an electrode composition, which is wet powder including an active material and an electrolyte solution, to a predetermined supply position along the conveying direction of the base film; and a width guide part (1600) that controls the width of the electrode composition supplied onto the base film at the supply position.

### FIELD OF THE INVENTION

This invention relates to a battery electrode manufacturing device and a battery electrode manufacturing method.

### BACKGROUND ART

Lithium-ion batteries are high-capacity secondary batteries and have come to be widely used in a variety of usages. An electrode of a lithium-ion battery is composed of an active material layer, a current collector layer, a separator, and a frame member that encapsulates the active material layer (for example, referring to Patent Reference 1). The active material layer of the lithium-ion battery can be formed, for example, by supplying an electrode composition to a strip-shaped substrate film and compressing it with a roll press or the like.

As a method for supplying the electrode composition to the substrate film, a method using a hopper may be considered. Specifically, it is possible to control the electrode composition that can be held in a hopper, and the electrode composition that can be appropriately supplied from the hopper to the base film. For example, in Patent Reference 2, an electrode composition is held in a hopper, and an endless belt is used to convey the electrode composition to the opening of the hopper. Thus, the electrode composition is applied to a sheet-like substrate positioned below the opening of the hopper.

### CITATION LIST

### Patent Literature

[Patent Reference 1] Publication of Japanese Patent No. 6633866
[Patent Reference 2] Japanese Unexamined Patent Application Publication No. 2020-161303
[Patent Reference 3] Japanese Unexamined Patent Application Publication No. 2021-27043
[Patent Reference 4] Japanese Unexamined Patent Application Publication No. 2010-174264
[Patent Reference 5] Japanese Unexamined Patent Application Publication No. S62-23982

### BRIEF SUMMARY OF THE INVENTION

### Problems that Invention is to Solve

In a case when an electrode composition is placed on a substrate film, the electrode composition may spread out on the substrate film and not keep a predetermined shape. Here, an electrode composition is a wet powder containing an electrolyte solution. Therefore, it is characterized that an electrode composition has poor flowability and is fixed when pressure is applied. It is not easy to shape such an electrode composition on a substrate film in a later step due to the relationship with a frame member and the like. Furthermore, Patent Reference 3 describes a technique for removing excess electrode composition from a substrate using a mask. However, this technique requires a complicated device configuration and process, and is not preferable from the viewpoint of yield.

The present invention has been made in view of the above-mentioned problems and has an objective to provide a battery electrode manufacturing device and a battery electrode manufacturing method that can easily and efficiently adjust the shape of an electrode composition, which is placed on a substrate film.

### Means to Solve the Problems

In order to achieve the objective, a battery electrode manufacturing device of this invention comprises: a conveying part that conveys a strip-shaped base film; an electrode composition supply part that supplies an electrode composition, which is wet powder including an active material and an electrolyte solution, to a predetermined supply position along the conveying direction of the base film; and a width guide part that controls the width of the electrode composition supplied onto the base film at the supply position.

### Effects of the Invention

A battery electrode manufacturing device and a battery electrode manufacturing method, according to this invention, can easily and efficiently adjust the shape of an electrode composition, which is placed on a substrate film.

### BRIEF DESCRIPTION OF DRAWINGS

FIG. 1 is a schematic cross-sectional diagram of a single cell of a battery manufactured using the battery electrode manufacturing device according to the first embodiment.

FIG. 2 is a schematic diagram of the battery electrode manufacturing device according to the first embodiment.

FIG. 3A is a diagram showing an example of an electrode composition supply device according to the first embodiment.

FIG. 3B is a diagram for explaining the width guide device according to the first embodiment.

FIG. 4 is a diagram showing an example of the width guide device according to the first embodiment.

FIG. 5 is a diagram showing an example of the width guide device according to the first embodiment.

FIG. 6A is a diagram showing an example of the width guide device according to the first embodiment.

FIG. 6B is a diagram showing an example of the width guide device according to the first embodiment.

FIG. 7A is a diagram showing an example of the width guide device according to the first embodiment.

FIG. 7B is a diagram showing an example of the width guide device according to the first embodiment.

FIG. 8 is a schematic diagram of the battery electrode manufacturing device according to the second embodiment.

FIG. 9 is a diagram for explaining the roller and the first suppression part according to the second embodiment.

FIG. 10 is a diagram for explaining the roller and the first suppression part according to the second embodiment.

FIG. 11 is a diagram showing an example of the second suppression part according to the second embodiment.

FIG. 12 is a diagram showing an example of the second suppression part according to the second embodiment.

FIG. 13 is a diagram showing an example of the second suppression part according to the second embodiment.

FIG. 14A is a diagram showing an example of the second suppression part according to the second embodiment.

FIG. 14B is a diagram showing an example of the second suppression part according to the second embodiment.

FIG. 15 is a diagram for explaining the roller and the first suppression part according to the second embodiment.

FIG. 16 is a diagram showing an example of the second suppression part according to the second embodiment.

FIG. 17 is a diagram showing an example of the second suppression part according to the second embodiment.

FIG. 18 is a diagram showing an example of the second suppression part according to the second embodiment.

FIG. 19 is a diagram showing an example of the second suppression part according to the second embodiment.

FIG. 20 is a diagram showing an example of the second suppression part according to the second embodiment.

### DESCRIPTION OF EMBODIMENTS

### First Embodiment

Hereinafter, the embodiment of the present invention will be explained by referring to the figures. Herein, in the figures used in the following explanations, some characteristic parts may be enlarged for the purpose of emphasizing said characteristic parts. Therefore, the dimensional ratios of each component are not necessarily the same as the real ones. In addition, for the same purpose, a part of the present invention may be omitted from the figures.

### <Assembled Battery (Secondary Battery)>

The battery electrode manufacturing device and the battery electrode manufacturing method of the embodiment are applied, for example, to the manufacture of lithium-ion batteries. Lithium-ion batteries can be used, for example, in the form of a battery pack whose voltage and capacity can be adjusted with an assembled battery that is made into a module by combining lithium-ion cells (also written as single cell or battery cell) or by combining multiple such assembled batteries.

### <Single Cell (Battery Cell)>

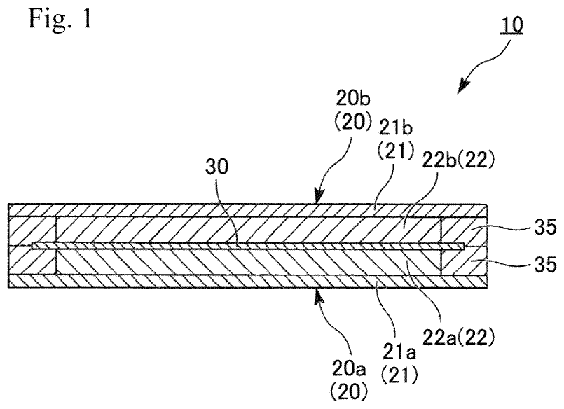

FIG. 1 is a schematic cross-sectional view of a single cell 10. It is possible to produce the above assembled battery by combining a plurality of single cells 10. For example, the single cell 10 comprises a cathode 20a and an anode 20b as two electrodes 20 (battery electrodes), and a separator 30.

The separator 30 is arranged between the cathode 20a and the anode 20b. In terms of the assembled battery, a plurality of single cells 10 are stacked where the cathode 20a and the anode 20b are facing at the same direction.

The separator 30 holds an electrolyte. Thereby, the separator 30 functions as an electrolyte layer. The separator 30 is arranged between the electrode active material layers 22 of the cathode 20a and the anode 20b, and prevents them from contacting with each other. Thereby, the separator 30 functions as a partition between the cathode 20a and the anode 20b.

Examples of the electrolyte held in the separator 30 include an electrolytic solution or a gel polymer electrolyte. The separator 30 ensures high lithium-ion conductivity by using these electrolytes. Examples of the form of the separator include a porous sheet separator made of a polymer or fiber that absorbs and retains the electrolyte, a nonwoven fabric separator, and the like.

The cathode 20a and the anode 20b each comprise a current collector 21, an electrode active material layer 22, and a frame member 35. The electrode active material layer 22 and the current collector 21 are arranged in this order from the separator 30 side. The frame member 35 is frame-shaped (annular). The frame member 35 surrounds the electrode active material layer 22. The frame member 35 of the cathode 20a and the frame member 35 of the anode 20b are welded together and integrated. In the following description, when the electrode active material layers 22 of the cathode 20a and the anode 20b are to be distinguished from each other, they will be referred to as a cathode active material layer 22a and an anode active material layer 22b, respectively.

### <Specific Example of Cathode Current Collector>

As the cathode current collector constituting the cathode current collector layer 21a, a current collector used in a known lithium-ion cell can be used. For example, as the cathode current collector, a known metal current collector and a resin current collector composed of a conductive material and a resin (resin current collector described in JP 2012-150905 and WO 2015/005116, etc.), can be used. The cathode current collector constituting the cathode current collector layer 21a is preferably a resin current collector from the viewpoint of battery characteristics and the like.

Examples of metal current collectors include copper, aluminum, titanium, nickel, tantalum, niobium, hafnium, zirconium, zinc, tungsten, bismuth, antimony, alloys containing one or more of these metals, and one or more metal materials selected from the group consisting of stainless steel alloys. These metal materials may be used in the form of a thin plate, metal foil, or the like. Furthermore, a substrate, which is made of a material other than the above-described metal material, on which the above-mentioned metal material is formed by sputtering, electrodeposition, coating or the like, may be used as the metal current collector.

The resin current collector preferably contains a conductive filler and a matrix resin. Examples of the matrix resin include polyethylene (PE), polypropylene (PP), polymethylpentene (PMP), etc., but are not particularly limited. The conductive filler is not particularly limited as long as it is selected from materials having conductivity. The conductive filler may be a conductive fiber having a fibrous shape.

The resin current collector may contain other components (dispersant, crosslinking accelerator, crosslinking agent, coloring agent, ultraviolet absorber, plasticizer, etc.) in addition to the matrix resin and the conductive filler. Further, a plurality of resin current collectors may be stacked and used, or a resin current collector and a metal foil may be stacked and used.

The thickness of the cathode current collector layer 21a is not particularly limited, but is preferably 5 to 150 μm. When a plurality of resin current collectors are stacked and used as the cathode current collector layer 21a, the total thickness after stacking is preferably 5 to 150 μm. The cathode current collector layer 21a can be obtained, for example, by molding a conductive resin composition obtained by melt-kneading a matrix resin, a conductive filler, and an optional filler dispersant into a film-shaped composition by a known method.

### <Specific Examples of Cathode Active Materials>

The cathode active material layer 22a is preferably a non-bound body of a mixture containing the cathode active material. Herein, a non-bound body means that the position of the cathode active material in the cathode active material layer is not fixed, and the cathode active materials and the cathode active material and the current collector are irreversibly fixed from each other. When the cathode active material layer 22a is a non-bound body, since the cathode active materials are not irreversibly fixed to each other, the interface between the cathode active materials can be separated without mechanical damages. Therefore, even when stress is applied to the cathode active material layer 22a, the transfer of the cathode active material can prevent destruction of the cathode active material layer 22a, which is preferable. The cathode active material layer 22a, which is a non-bound body, can be obtained by a method of changing the cathode active material layer 22a to the cathode active material layer 22a that contains a cathode active material and an electrolytic solution, and that does not contain a binder. Here, in this specification, the binder refers to an agent that cannot reversibly fix the cathode active material to each other and the cathode active material to the current collector, and known solvent-drying type binders for lithium ion batteries such as starch, polyvinylidene fluoride, polyvinyl alcohol, carboxymethyl cellulose, polyvinylpyrrolidone, tetrafluoroethylene, styrene-butadiene rubber, polyethylene and polypropylene may be exemplified. These binders are used by being dissolved or dispersed in a solvent, and are solidified by volatilizing and distilling off the solvent without the surface becoming sticky. Therefore, it is not possible to reversibly fix the cathode active materials, or the cathode active material and the current collector.

Examples of the cathode active material include a composite oxide of lithium and a transition metal, a composite oxide having two kinds of transition metal elements, a composite oxide having three or more kinds of metal elements and the like, but are not particularly limited.

The cathode active material may be a coated cathode active material in which at least a part of the surface is covered with a coating material containing a polymer compound. When the outer periphery of the cathode active material is covered with a coating material, volume change of the cathode is alleviated, and expansion of the cathode can be suppressed.

As the polymer compound constituting the coating material, those described as a resin for coating active material mentioned in JP 2017-054703 and WO 2015/005117 can be suitably used.

The coating material may contain a conductive assistant. As the conductive assistant, the same conductive filler contained in the cathode current collector layer 21a, can be suitably used.

The cathode active material layer 22a may contain adhesive resin. As the adhesive resin, those described as a mixture of a resin for coating non-aqueous secondary battery active materials, which is mentioned in Japanese Unexamined Patent Application, First Publication No. 2017-054703, and a small amount of organic solvent with adjusting the glass transition temperature below room temperature, and as an adhesive resin mentioned in Japanese Unexamined Patent Application, First Publication No. H10-255805 or the like, can be used. Here, the adhesive resin means a resin having pressure-sensitive adhesiveness (an adhering property obtained by applying a slight pressure without using water, solvent, heat, or the like) without solidifying even in a case where a solvent component is volatilized and dried. On the other hand, a solution-drying type binder for an electrode, which is used as a binding material, means a binder that dries and solidifies in a case where a solvent component is volatilized, thereby firmly adhering and fixing active materials to each other. As a result, the binder (the solution-drying type electrode binder) and the adhesive resin are different materials.

The cathode active material layer 22a may contain an electrolytic solution that contains an electrolyte and a non-aqueous solvent. As the electrolyte, those used in the known electrolytic solution can be used. As the non-aqueous solvent, those used in known electrolytic solutions (for example, phosphoric acid esters, nitrile compounds, etc., mixtures thereof, etc.) can be used. For example, a mixture of ethylene carbonate (EC) and dimethyl carbonate (DMC) or a mixture of ethylene carbonate (EC) and propylene carbonate (PC) can be used.

The cathode active material layer 22a may contain a conductive assistant. As the conductive assistant, a conductive material similar to the conductive filler contained in the cathode current collector layer 21a, can be suitably used.

The thickness of the cathode active material layer 22a is not particularly limited, but from the viewpoint of battery performance, it is preferably 150 to 600 μm, more preferably 200 to 450 μm.

In this embodiment, a cathode composition, which is supplied to form the cathode active material layer 22a, is a wet powder containing a cathode active material and non-aqueous electrolytic solution. Also, it is preferable that the wet powder is in a condition of pendula or funicular.

The ratio of the non-aqueous electrolytic solution in the wet powder is not particularly limited, but if the pendula or funicular condition is necessary, in terms of the cathode, it is preferable that the proportion of the non-aqueous electrolyte is 0.5 to 15% by weight of the entire wet powder.

### <Specific Example of Anode Current Collector>

As the anode current collector constituting the anode current collector layer 21b, one having the same structure as that described for the cathode current collector can be appropriately used. It also can be obtained by the same method. The anode current collector layer 21b is preferably a resin current collector from the viewpoint of battery characteristics and the like. The thickness of the anode current collector layer 21b is not particularly limited, but is preferably 5 to 150 μm.

### <Specific Examples of Anode Active Materials>

It is preferable that the anode active material layer 22b is a non-bound body of a mixture containing the anode active material. The reason why it is preferable that the anode active material layer is a non-bound body, is the same reason why it is preferable that the cathode active material layer 22a is a non-bound body. The method of obtaining the anode active material layer 22b which is a non-bound body, is the same as the method of obtaining the cathode active material layer 22a which is a non-bound body.

As the anode active material, for example, carbon-based materials, silicon-based materials, and mixtures thereof can be used, but there is no particular limitation.

The anode active material may be a coated anode active material, where at least a part of a surface of the coated anode active material is coated with a coating material containing a macromolecule compound. In a case where the outer periphery of the anode active material is covered by a coating material, the volume change of the anode is alleviated, and thus the expansion of the anode can be suppressed.

As the coating material, the same one as the coating material constituting the coated cathode active material can be suitably used.

The anode active material layer 22b contains an electrolyte and an electrolytic solution that contains a non-aqueous solvent. Regarding the composition of the electrolytic solution, an electrolytic solution similar to that contained in the cathode active material layer 22a can be suitably used.

The anode active material layer 22b may contain a conductive assistant. As the conductive assistant, a conductive material similar to the conductive filler contained in the cathode active material layer 22a can be suitably used.

The anode active material layer 22b may contain adhesive resin. As the adhesive resin, the same adhesive resin as the optional component of the cathode active material layer 22a can be suitably used.

The thickness of the anode active material layer 22b is not particularly limited, but from the viewpoint of battery performance, it is preferably 150 to 600 μm, more preferably 200 to 450 μm.

In this embodiment, a anode composition, which is supplied to form the anode active material layer 22a, is a wet powder containing an anode active material and non-aqueous electrolytic solution. Also, it is preferable that the wet powder is in a condition of pendula or funicular.

The ratio of the non-aqueous electrolytic solution in the wet powder is not particularly limited, but if the pendula or funicular condition is necessary, in terms of the anode, it is preferable that the proportion of the non-aqueous electrolyte is 0.5 to 25% by weight of the entire wet powder.

### <Specific Example of Separator>

Examples of the electrolyte held in the separator 30 include an electrolytic solution or a gel polymer electrolyte. The separator 30 ensures high lithium-ion conductivity by using these electrolytes. The form of the separator 30 includes, for example, a porous film made of polyethylene or polypropylene, but is not particularly limited.

### <Specific Example of Frame Member>

The frame member 35 is not particularly limited as long as it is made of a material that is durable against the electrolytic solution, but a polymer material is preferable, and a thermosetting polymer material is more preferable. The material constituting the frame member 35 may be any material as long as it has insulation properties, sealing properties (liquid tightness), heat resistance under the battery operating temperature, etc., and a resin material is suitably selected. Specifically, epoxy resins, polyolefin resins, polyester resins, polyurethane resins, polyvinidene fluoride resins, etc. may be used for the frame member 35.

### <Battery Electrode Manufacturing Device and Battery Electrode Manufacturing Method>

Next, a manufacturing device and a battery electrode manufacturing method (hereinafter simply referred to as a manufacturing method) of the present embodiment, will be described. For example, as for the battery electrode manufacturing device and the battery electrode manufacturing method, first, the cathode 20a and the anode 20b are manufactured. The manufacturing method for the cathode 20a and the manufacturing method for the anode 20b differ mainly in the electrode active material contained in the electrode active material layer 22. Herein, as a manufacturing method for the electrode 20, the manufacturing method for the cathode 20a and the anode 20b will be described together.

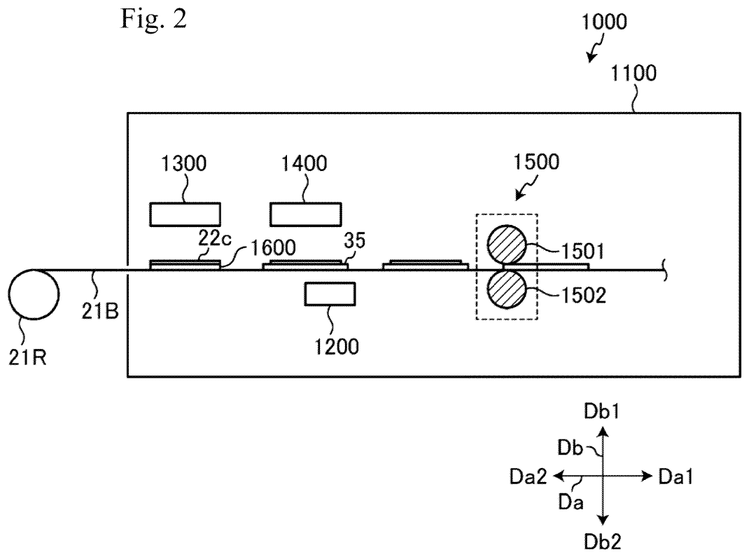

FIG. 2 is a schematic diagram showing the battery electrode manufacturing device 1000. For example, the battery electrode manufacturing device 1000 comprises a chamber 1100, a conveyance device 1200, an electrode composition supply device 1300, a frame member supply device 1400, a press device 1500, and a width guide device 1600. Hereinafter, a case where the strip-shaped base film is the strip-shaped current collector 21B will be described as an example.

The chamber 1100 is a room whose interior is decompressed and maintained below atmospheric pressure. The pressure inside the chamber 1100 is decompressed below atmospheric pressure by a decompress pump (not shown in the figure). The standard atmospheric pressure is approximately 1013 hPa (approximately 10⁵ Pa).

For example, the current collector roll 21R is arranged outside the chamber 1100. The strip-shaped current collector 21B pulled out from the current collector roll 21R is conveyed into the chamber 1100 through the slit. Hereinafter, the strip-shaped current collector 21B may be referred to as the current collector 21B. Note that the current collector 21B is the current collector 21 before being cut into a predetermined shape. The current collector 21B is conveyed along the conveying direction Da. In the following description, the direction in which the current collector 21B is conveyed is referred to as the downstream side Da1, and the opposite direction is referred to as the upstream side Da2. Note that the external space of the chamber 1100 in which the current collector roll 21R is arranged may be at normal pressure or may be reduced in pressure by a chamber, which is different from the chamber 1100.

As shown in FIG. 2, the upper side in the vertical direction Db is designated as Db1, and the lower side in the vertical direction Db is designated as Db2. The direction perpendicular to the conveying direction Da and the vertical direction Db corresponds to the width direction of the current collector 21B and the width direction of the electrode composition 22c placed on the current collector 21B.

The conveyance device 1200 conveys the current collector 21B to the downstream side Da1 along the conveying direction Da. For example, the conveying device 1200 is a belt conveyor that supports the current collector 21B from below. After the electrode composition 22c is supplied by the electrode composition supply device 1300 described below, the conveying device 1200 conveys the current collector 21B on which the electrode composition 22c is placed. After the frame member supply device 1400 described below supplies the frame member 35, the conveying device 1200 conveys the frame member 35 and the current collector 21B on which the electrode composition 22c is placed. The conveying device 1200 is an example of a conveying part.

As shown in FIG. 2, the electrode composition supply device 1300 supplies the electrode composition 22c onto the current collector 21B conveyed in the chamber 1100. As mentioned above, in this embodiment, in order to form the electrode active material layer 22 (cathode active material layer 22a, anode active material layer 22b), the electrode composition 22c (cathode composition, anode composition) supplied from the electrode composition supply device 1300 is a wet powder containing an electrode active material (cathode active material, anode active material) and an electrolytic solution (non-aqueous electrolyte). Also, in this embodiment, it is preferable that the wet powder as the electrode composition 22c is in a condition of pendula or funicular. In addition, the electrode active material is a coated electrode active material coated with a coating material containing a polymer compound. The electrode active material contained in the electrode composition 22c is a coated electrode active material. Therefore, during the step of supplying the electrode composition 22c onto the current collector 21B, it is necessary to keep the electrode composition 22c in a soft state.

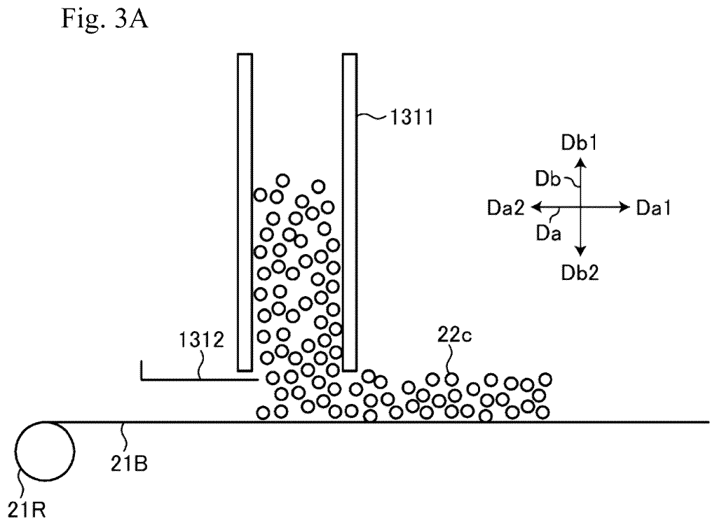

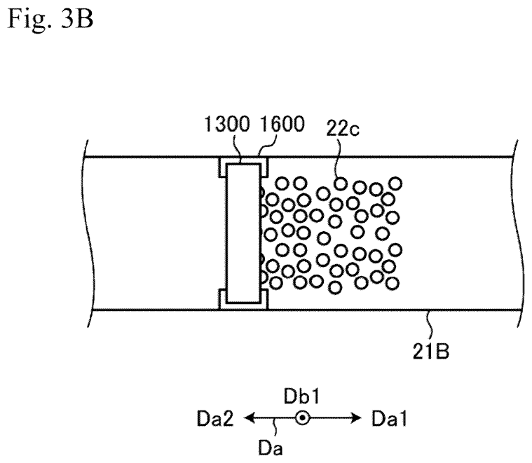

The specific configuration of the electrode composition supply device 1300 is not particularly limited as long as it is possible to supply the electrode composition 22c to a predetermined supply position along the conveying direction Da of the current collector 21B. As an example, the electrode composition supply device 1300 is composed of a hopper 1311 and a shutter 1312, shown in FIG. 3A. Specifically, the electrode composition supply device 1300 holds the electrode composition 22c inside the hopper 1311 having an opening on the lower side Db2 along the vertical direction Db. Then, by opening and closing the opening of the hopper 1311 with the shutter 1312, the electrode composition 22c can be supplied to a predetermined supply position.

The predetermined supply position along the conveying direction Da of the current collector 21B is a predetermined position in a coordinate system based on the ground or the like. The electrode composition 22c supplied to the predetermined supply position is conveyed to the downstream side Da1 along the conveying direction Da by the conveyance device 1200 together with the current collector 21B.

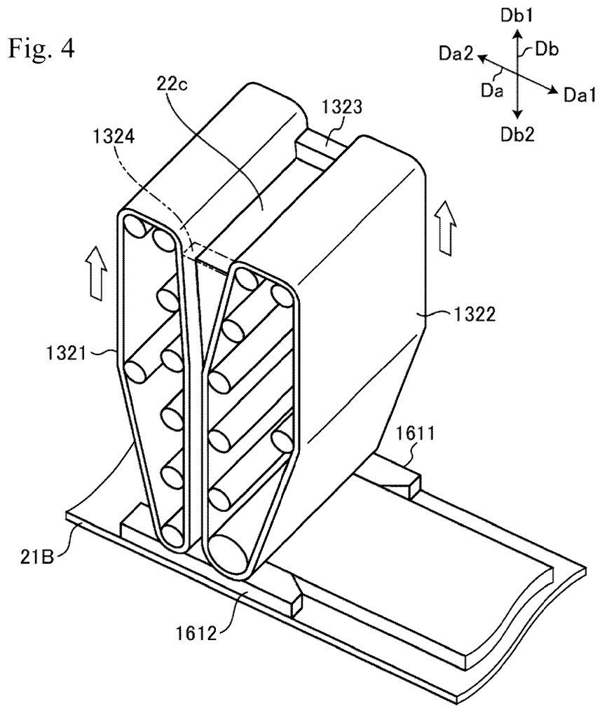

Herein, in a case when the electrode composition 22c is placed on the current collector 21B, the electrode composition 22c may spread out on the current collector 21B and not keep a predetermined shape. Therefore, the battery electrode manufacturing device 1000 of the first embodiment comprises a width guide device 1600 at the above-mentioned predetermined supply position, as shown in FIG. 3B. The width guide device 1600 controls the width of the electrode composition 22c supplied onto the current collector 21B at the above-mentioned predetermined supply position. Hereinafter, specific examples of the width guide device 1600 will be described with reference to FIGS. 4, 5, 6A, 6B, 7A, and 7B.

Herein, in FIGS. 4 to 7B, an example of the electrode composition supply device 1300 will be described, in a case when a moving belt is used to supply the electrode composition 22c. For example, the electrode composition supply device 1300 shown in FIGS. 4 to 7B comprises a moving belt 1321, a moving belt 1322, a side plate 1323, and a side plate 1324. That is, the electrode composition supply device 1300 has the hopper formed by the moving belt 1321, the moving belt 1322, the side plate 1323, and the side plate 1324. The hopper holds the electrode composition 22c therein. The electrode composition supply device 1300 controls the operations of the moving belts 1321 and 1322 to supply the electrode composition 22c to the current collector 21B.

More specifically, each of moving belts 1321 and 1322 comprises a ring-shaped member that rotates on a rotation axis parallel to the width direction (direction perpendicular to the conveying direction Da and the vertical direction Db) of the current collector 21B and the electrode composition 22c, and a drive roller that drives the ring-shaped member. The electrode composition supply device 1300 supplies the electrode composition 22c to the current collector 21B by rotating each of the ring-shaped members of the moving belts 1321 and 1322 along the direction of the arrow shown in FIG. 4. On the other hand, the electrode composition supply device 1300 stops the supply of the electrode composition 22c by stopping or reversing the rotation of each ring-shaped member.

FIG. 4 shows an example of the width guide device 1600, which includes members 1611 and 1612 fixed at the predetermined supply position. That is, while the current collector 21B and the electrode composition 22c placed thereon are sequentially conveyed to the downstream side Da1 along the conveying direction Da, the position of the width guide device 1600 along the transport direction Da is fixed.

As shown in FIG. 4, the members 1611 and 1612 adjust the width direction dimension and the shape of the side surface of electrode composition 22c by being in contact with both ends of the electrode composition 22c along the width direction, wherein the electrode composition 22c is supplied onto the current collector 21B. The width guide device 1600 can adjust the shape of the electrode composition 22c without wasting the electrode composition 22c and without complicating the device configuration and process. That is, the width guide device 1600 can easily and efficiently adjust the shape of the electrode composition 22c placed on the current collector 21B.

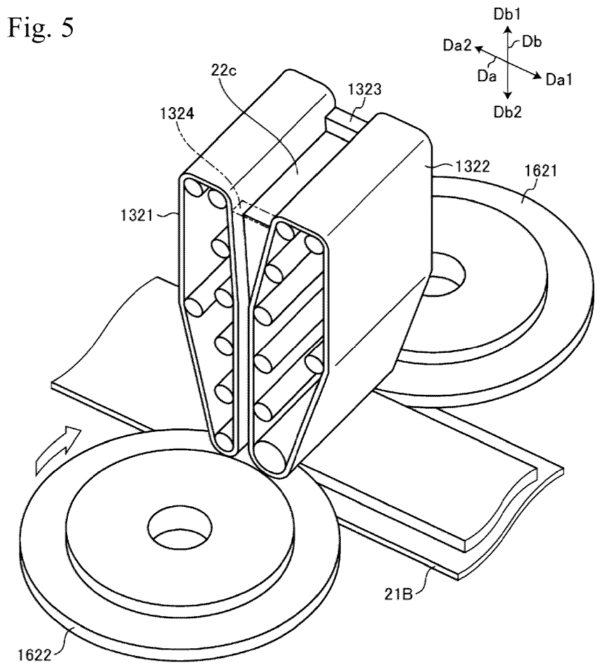

The positions of the members 1611 and 1612 along the transport direction Da are fixed and their relative positions move with respect to the electrode composition 22c conveyed along the transport direction Da. This may cause friction between the members 1611 and 1612 and the electrode composition 22c, resulting in roughening of the side surfaces of the electrode composition 22c. Therefore, as shown in FIGS. 5 to 7B, the width guide device 1600 may be configured so that the surface, which is in contact with the electrode composition 22c, does not move relative to the electrode composition 22c being conveyed. Specifically, the width guide device 1600 comprises members that are in contact with both ends of the electrode composition 22c supplied onto the current collector 21B along the width direction at the above-mentioned predetermined supply position, and a driving device that conveys the members at the same speed as the current collector 21B and the electrode composition 22c, which move toward the downstream side Da1 along the conveying direction Da, while the members are in contact with both ends of the electrode composition 22c along the width direction.

In FIG. 5, a disk-shaped member 1621 and a disk-shaped member 1622 are shown as an example of the width guide device 1600. The disk-shaped members 1621 and 1622 rotate around the vertical direction Db as their rotation axis. In FIG. 5, the width guide device 1600 further comprises a driving device (not shown). The driving device rotates the disk-shaped members 1621 and 1622 using power, which is generated by a motor or the like.

Specifically, the driving device rotates the disk-shaped members 1621 and 1622 so that the speed of the positions of the disk-shaped members 1621 and 1622 is the same as the speed of the current collector 21B and the electrode composition 22c, while said positions are in contact with the electrode composition 22c. In FIG. 5, the driving device rotates the disk-shaped member 1622 along the direction indicated by the arrow in FIG. 5 and the disk-shaped member 1621 along the opposite direction of the disk-shaped member 1622.

The disk-shaped members 1621 and 1622 are in contact with both ends of the electrode composition 22c, which is supplied onto the current collector 21B, along the width direction. Thereby, the disk-shaped members 1621 and 1622 can adjust the width direction dimension and the shape of the side surface of the electrode composition 22c. The disk-shaped members 1621 and 1622 can adjust the shape of the electrode composition 22c without wasting the electrode composition 22c and without complicating the device configuration and process. Furthermore, the contact surfaces of the disk-shaped members 1621 and 1622 are controlled to move at the same speed as the electrode composition 22c so as not to generate friction with the electrode composition 22c. That is, the disk-shaped members 1621 and 1622 make it possible to easily, efficiently, and more accurately adjust the shape of the electrode composition 22c, which is placed on the current collector 21B.

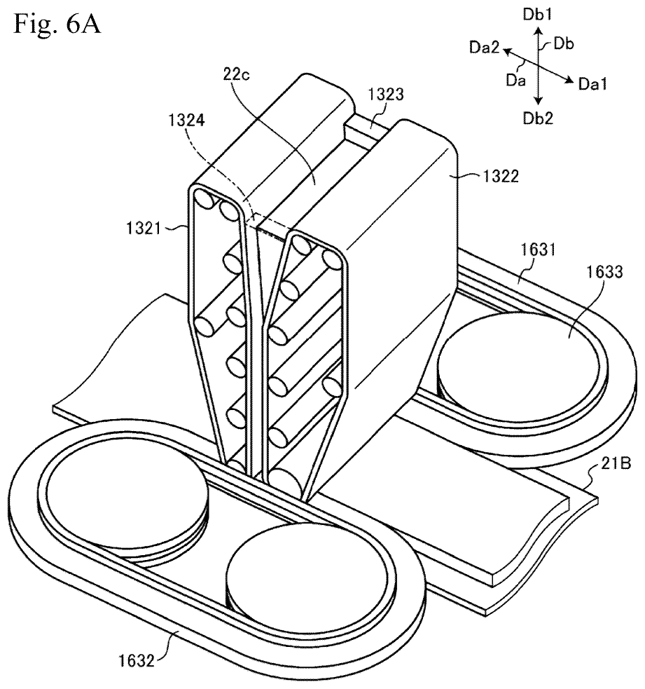

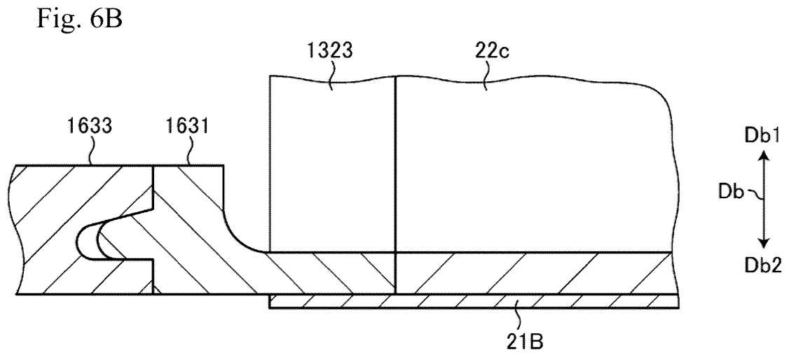

In FIG. 6A, the ring-shaped members 1631 and 1632 are shown as an example of the width guide device 1600. The ring-shaped members 1631 and 1632 rotate around the vertical direction Db as their rotation axis using a driving device such as a roller 1633. Specifically, the driving device rotates the ring-shaped members 1631 and 1632 so that the speed of the positions of the ring-shaped members 1631 and 1632 is the same as the speed of the current collector 21B and the electrode composition 22c, while said positions are in contact with the electrode composition 22c.

The width guide device 1600 in FIG. 6A will be described in more detail with reference to FIG. 6B. The ring-shaped member 1631 and the roller 1633 that drives the ring-shaped member 1631 are illustrated in an enlarged manner in FIG. 6B. The thickness (dimension in the vertical direction Db) of the ring-shaped member 1631 is controlled so that it can be fitted into the gap between the side plate 1323 and the current collector 21B. In addition, the ring-shaped member 1631 has the same thickness as the electrode composition 22c, which is placed on the current collector 21B. Thus, the ring-shaped member 1631 is in contact with the side surface of the electrode composition 22c, which is supplied onto the current collector 21B, through the gap between the side plate 1323 and the current collector 21B.

The ring-shaped members 1631 and 1632 are in contact with both ends of the electrode composition 22c, which is supplied onto the current collector 21B, along the width direction. Thereby, the ring-shaped members 1631 and 1632 can adjust the width direction dimension and the shape of the side surface of the electrode composition 22c. The ring-shaped members 1631 and 1632 can adjust the shape of the electrode composition 22c without wasting the electrode composition 22c and without complicating the device configuration and process. Furthermore, the contact surfaces of the ring-shaped members 1631 and 1632 are controlled to move at the same speed as the electrode composition 22c so as not to generate friction with the electrode composition 22c. That is, the ring-shaped members 1631 and 1632 make it possible to easily, efficiently, and more accurately adjust the shape of the electrode composition 22c, which is placed on the current collector 21B.

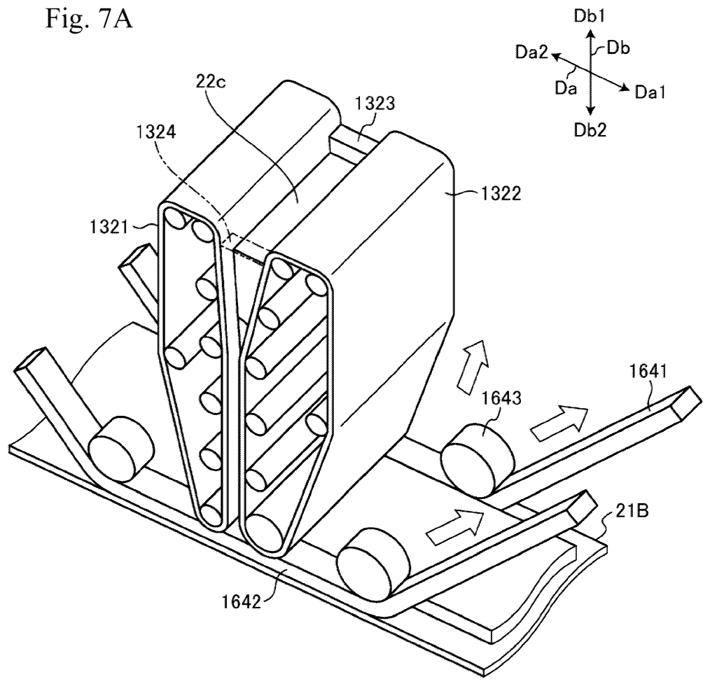

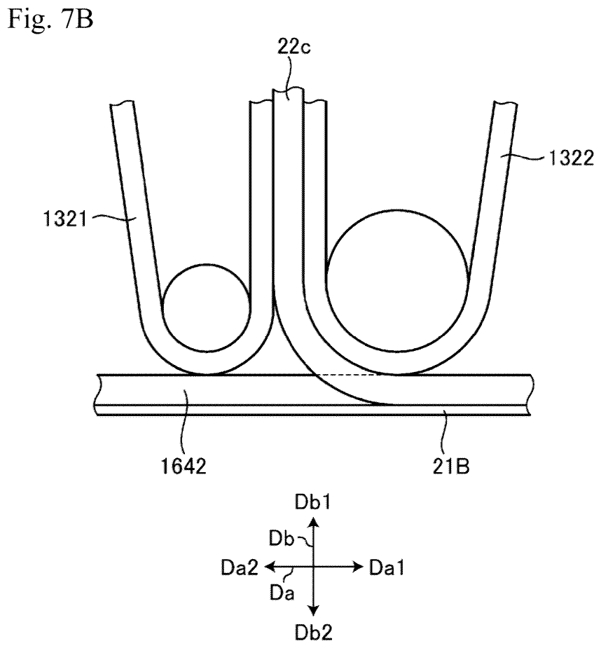

FIG. 7A shows ring-shaped members 1641 and 1642 as an example of the width guide device 1600. The ring-shaped members 1641 and 1642 are rotated by a driving device such as rollers 1643 around the width direction as the rotation axis. Specifically, the driving device such as the rollers 1643 rotates the ring-shaped members 1641 and 1642 so that the speed of the positions of the ring-shaped members 1641 and 1642 is the same as the speed of the current collector 21B and the electrode composition 22c, while said positions are in contact with the electrode composition 22c.

The width guide device 1600 in FIG. 7A will be described in more detail with reference to FIG. 7B. The ring-shaped member 1642 is illustrated in an enlarged manner in FIG. 7B. As shown in FIG. 7B, the ring-shaped member 1642 has the same thickness as the electrode composition 22c disposed on the current collector 21B. The thickness of the ring-shaped member 1642 is controlled so that it can be fitted into the gap between the side plate 1323 and the current collector 21B. The ring-shaped member 1641 is in contact with the electrode composition 22c, which is supplied onto the current collector 21B, through the gap between the side plate 1323 and the current collector 21B.

The ring-shaped members 1641 and 1642 is in contact with both ends of the electrode composition 22c, which is supplied onto the current collector 21B, along the width direction. Thereby, the ring-shaped members 1631 and 1632 can adjust the width direction dimension and the shape of the side surface of the electrode composition 22c. The ring-shaped members 1641 and 1642 can adjust the shape of the electrode composition 22c without wasting the electrode composition 22c and without complicating the device configuration and process. Furthermore, the contact surfaces of the ring-shaped members 1641 and 1642 are controlled to move at the same speed as the electrode composition 22c so as not to generate friction with the electrode composition 22c. That is, the ring-shaped members 1641 and 1642 make it possible to easily, efficiently, and more accurately adjust the shape of the electrode composition 22c, which is placed on the current collector 21B.

Furthermore, the disk-shaped member 1621 and the disk-shaped member 1622 shown in FIG. 5 and the ring-shaped member 1631 and the ring-shaped member 1632 shown in FIG. 6A each includes a portion that moves along the width direction. In other words, the disk-shaped member 1621, the disk-shaped member 1622, the ring-shaped member 1631, and the ring-shaped member 1632 move at the same speed as the current collector 21B along the conveying direction Da, thereby they can avoid friction. However, there may be friction with current collector 21B along the width direction. On the other hand, the ring-shaped member 1641 and the ring-shaped member 1642 shown in FIG. 7A do not include any portion that moves along the width direction, and therefore friction with current collector 21B can be avoided.

The explanation will be continued returning to FIG. 2. The frame member supply device 1400 supplies a frame member 35 to the current collector 21B being conveyed. For example, the frame member supply device 1400 has a robot arm and places the frame member 35, which has been manufactured in advance, at a predetermined position on the current collector 21B being conveyed. Alternatively, the frame member supply device 1400 may manufacture the frame member 35 on the current collector 21B. For example, in a case when the current collector 21B is used as a substrate, the frame member 35 can be formed on the current collector 21B by discharging or applying a predetermined material in a predetermined shape onto the current collector 21B using a dispenser, coater, etc.

The press device 1500 compresses the electrode composition 22c supplied onto the current collector 21B. For example, the press device 1500 has an upper roller 1501 and a lower roller 1502 as shown in FIG. 2. The press device 1500 sandwiches and compresses the electrode composition 22c supplied to the current collector 21B using the upper roller 1501 and the lower roller 1502. That is, the press device 1500 performs roll pressing on the electrode composition 22c.

In FIG. 2, an example has been described in a case where the electrode composition supply device 1300 supplies the electrode composition 22c, and then the frame member supply device 1400 supplies the frame member 35. However, the embodiments are not limited to this. For example, after the frame member supply device 1400 supplies the frame member 35, the electrode composition supply device 1300 may supply the electrode composition 22c to the position inside the frame member 35. Further, although FIG. 2 shows a case where the frame member supply device 1400 is disposed inside of the chamber 1100, the frame member supply device 1400 may be disposed outside of the chamber 1100.

As described above, in this embodiment, each process, such as supplying the electrode composition 22c by the electrode composition supply device 1300 and compressing the electrode composition 22c by the press device 1500, is performed within the chamber 1100, wherein the inside of the chamber 1100 is decompressed below atmospheric pressure. Due to this, it is possible to prevent air from remaining inside the electrode composition 22c, and the uniformity of the electrode active material layer 22 can be improved.

After the compression process by the press device 1500, the separator 30 shown in FIG. 1 is further supplied and the single cell 10 is produced in the end. The separator 30 may be continuously supplied to the current collector 21B and the electrode composition 22c conveyed along the conveying direction Da. Also, the separator 30 may be supplied in the form of a sheet after the current collector 21B, the electrode composition 22c, and the like are divided into predetermined units.

Furthermore, in the embodiment described above, the strip-shaped base film on which the electrode composition 22c is placed is explained as the strip-shaped current collector 21B. However, it is not limited to this. For example, instead of the strip-shaped current collector 21B shown in FIG. 2, a strip-shaped separator sheet or a strip-shaped release film may be used as the base film. The strip-shaped separator sheet can be later trimmed to form the separator 30 shown in FIG. 1.

For example, in a case when the separator sheet is used as the base film, the electrode composition 22c is supplied onto the separator sheet, and the current collector 21B is supplied onto the surface of electrode composition 22c opposite side from the separator sheet. Then, the separator sheet and the current collector 21B are trimmed to a predetermined shape, and further, the frame member 35 is provided, thereby completing the production of the cathode 20a or the anode 20b.

In addition, in a case when a release film is used as the base film, the electrode composition 22c is supplied onto the release film, the current collector 21B is supplied to the surface of the electrode composition 22c, wherein the surface is opposite from the release film, the release film is collected, and then a separator sheet is supplied to the surface opposite from the current collector 21B. Then, the separator sheet and the current collector 21B are trimmed to a predetermined shape, and further, the frame member 35 is provided, thereby completing the production of the cathode 20a or the anode 20b. Instead of supplying the separator sheet and then trimming it, the separator 30 may be supplied to the electrode composition 22c.

Alternatively, the electrode composition 22c is supplied onto the release film, the separator sheet is supplied to the surface of the electrode composition 22c, wherein the surface is opposite from the release film, the release film is collected, and then the current collector 21B is supplied to the surface opposite from the separator sheet. Then, the separator sheet and the current collector 21B are trimmed to a predetermined shape, and further, the frame member 35 is provided, thereby completing the production of the cathode 20a or the anode 20b. Instead of supplying the current collector 21B and then trimming it, the current collector 21, which has been trimmed to a certain shape, may be supplied to the electrode composition 22c.

### Second Embodiment

As described in the first embodiment, each process, such as supplying the electrode composition 22c to the base film, a roll press, and so on, is performed within the chamber, wherein the inside of the chamber 1100 is decompressed below atmospheric pressure. Thereby, it is possible to prevent air from remaining inside the electrode composition 22c, and the uniformity of the electrode active material layer 22 can be improved. For this purpose, a slit is provided in the chamber, and the base film is conveyed into the chamber through the slit.

In order to maintain a reduced pressure state within the chamber while providing the slit in the chamber, it is conceivable to configure the slit to be narrow so as to prevent a gap (clearance) from occurring between the base film and the slit. However, if there is no clearance, it is conceivable that the base film may be scratched or caught when passing through the slit.

As a technique for maintaining a reduced pressure state in a chamber, Patent Reference 4 shows a technique for reducing the pressure in the chamber to a high vacuum in multiple stages. Furthermore, Patent Reference 5 shows the way how to increase the airflow resistance by providing a long slit in the path of a strip-shaped member that moves continuously between the vacuum chamber and the outside. According to the configurations described in Patent References 4 and 5, it is possible to provide a clearance between the slit and the base film, but there is a problem in that a large-scale configuration is required.

Meanwhile, rollers for conveying the base film are provided outside the chamber. The roller is in close contact with the base film, and it can be said that air hardly passes between the roller and the base film. Therefore, it may be possible to suppress the inflow of air into the chamber by providing a member that fills the gap between the roller and the outer surface of the chamber. However, even with this configuration, a clearance is required to rotate the roller, and therefore the inflow of air into the chamber cannot be blocked.

Therefore, in the second embodiment, a method for maintaining a reduced pressure state in the chamber 1100 with a simple configuration will be described. Specifically, the battery electrode manufacturing device 2000 according to the second embodiment comprises: a chamber whose interior is decompressed below atmospheric pressure; a conveying part that conveys the strip-shaped base film into the chamber through a slit provided in the chamber by rotating two rollers while sandwiching the strip-shaped base film between the rollers provided outside the chamber; a first suppression part that is provided in a gap between the roller and an outer surface of the chamber, and that suppresses the inflow of air into the chamber; and a second suppression part that is provided in a gap between the roller and the first suppression part, and that suppresses the inflow of air into the chamber.

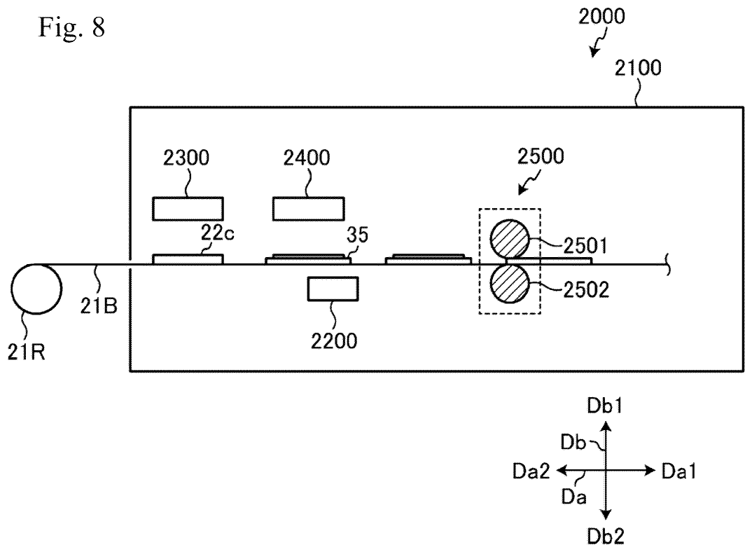

FIG. 8 is a schematic diagram of a battery electrode manufacturing device 2000 according to the second embodiment. For example, the battery electrode manufacturing device 2000 comprises a chamber 2100, a conveying device 2200, an electrode composition supply device 2300, a frame member supply device 2400, and a pressing device 2500. Hereinafter, a case where the strip-shaped base film is the strip-shaped current collector 21B will be described as an example.

The chamber 2100 is a room whose interior is decompressed and maintained below atmospheric pressure. The pressure inside the chamber 2100 is decompressed below atmospheric pressure by a decompress pump (not shown in the figure).

For example, the current collector roll 21R is arranged outside the chamber 2100. The strip-shaped current collector 21B pulled out from the current collector roll 21R is conveyed into the chamber 2100 through the slit. Hereinafter, the strip-shaped current collector 21B may be referred to as the current collector 21B. Note that the current collector 21B is the current collector 21 before being cut into a predetermined shape. The current collector 21B is conveyed along the conveying direction Da. In the following description, the direction in which the current collector 21B is conveyed is referred to as the downstream side Da1 and the opposite direction is referred to as the upstream side Da2. Note that the external space of the chamber 2100 in which the current collector roll 21R is arranged may be at normal pressure or may be reduced in pressure by a chamber, which is different from the chamber 2100.

As shown in FIG. 8, the upper side in the vertical direction Db is designated as Db1 and the lower side in the vertical direction Db is designated as Db2. The direction perpendicular to the conveying direction Da and the vertical direction Db corresponds to the width direction of the current collector 21B and the width direction of the electrode composition 22c placed on the current collector 21B.

The conveying device 2200 conveys the current collector 21B to the downstream side Da1 along the conveying direction Da. For example, outside the chamber 2100, the conveying device 2200 conveys the current collector 21B to the downstream side Da1 along the conveying direction Da by rotating the rollers while sandwiching the current collector 21B between two rollers. With this configuration, the conveying device 2200 conveys the current collector 21B into the chamber 2100 through the slit. Inside the chamber 2100, the conveying device 2200 conveys the current collector 21B to the downstream side Da1 along the conveying direction Da by a belt conveyor that supports the current collector 21B from below. After the electrode composition 22c is supplied by the electrode composition supply device 2300 described below, the conveying device 2200 conveys the current collector 21B on which the electrode composition 22c is placed. After the frame member supply device 2400 described below supplies the frame member 35, the conveying device 2200 conveys the frame member 35 and the current collector 21B on which the electrode composition 22c is placed. The conveying device 2200 is an example of a conveying part.

As shown in FIG. 8, the electrode composition supply device 2300 supplies the electrode composition 22c onto the current collector 21B conveyed in the chamber 2100. In one example, the electrode composition supply device 2300 is composed of a hopper and a shutter. In this case, the electrode composition supply device 2300 holds the electrode composition 22c inside the hopper 1 having an opening on the lower side Db2 along the vertical direction Db. The electrode composition supply device 2300 can supply a predetermined amount of the electrode composition 22c to a predetermined supply position by opening and closing the opening of the hopper with a shutter.

In this embodiment, in order to form the electrode active material layer 22 (cathode active material layer 22a, anode active material layer 22b), the electrode composition 22c (cathode composition, anode composition) supplied from the electrode composition supply device 1300 is a wet powder containing an electrode active material (cathode active material, anode active material) and an electrolytic solution (non-aqueous electrolyte). Also, in this embodiment, it is preferable that the wet powder as the electrode composition 22c is in a condition of pendula or funicular. In addition, the electrode active material is a coated electrode active material coated with a coating material containing a polymer compound. The electrode active material contained in the electrode composition 22c is a coated electrode active material. Therefore, during the step of supplying the electrode composition 22c onto the current collector 21B, it is necessary to keep the electrode composition 22c in a soft state.

The frame member supply device 2400 supplies a frame member 35 to the current collector 21B being conveyed. For example, the frame member supply device 2400 has a robot arm and places the frame member 35, which has been manufactured in advance, at a predetermined position on the current collector 21B being conveyed. Alternatively, the frame member supply device 2400 may manufacture the frame member 35 on the current collector 21B. For example, in a case when the current collector 21B is used as a substrate, the frame member 35 can be formed on the current collector 21B by discharging or applying a predetermined material in a predetermined shape onto the current collector 21B using a dispenser, coater, etc.

The press device 2500 compresses the electrode composition 22c supplied onto the current collector 21B. For example, the press device 2500 has an upper roller 2501 and a lower roller 2502 as shown in FIG. 8. The press device 2500 sandwiches and compresses the electrode composition 22c supplied to the current collector 21B using the upper roller 2501 and the lower roller 2502. That is, the press device 2500 performs roll pressing on the electrode composition 22c.

After the compression process by the press device 2500, the separator 30 shown in FIG. 1 is further supplied and the single cell 10 is produced in the end. The separator 30 may be continuously supplied to the current collector 21B and the electrode composition 22c conveyed along the conveying direction Da. Also, the separator 30 may be supplied in the form of a sheet after the current collector 21B, the electrode composition 22c and the like are divided into predetermined units.

In FIG. 8, an example has been described in a case where the electrode composition supply device 2300 supplies the electrode composition 22c, and then the frame member supply device 2400 supplies the frame member 35. However, the embodiments are not limited to this. For example, after the frame member supply device 2400 supplies the frame member 35, the electrode composition supply device 2300 may supply the electrode composition 22c to the position inside the frame member 35.

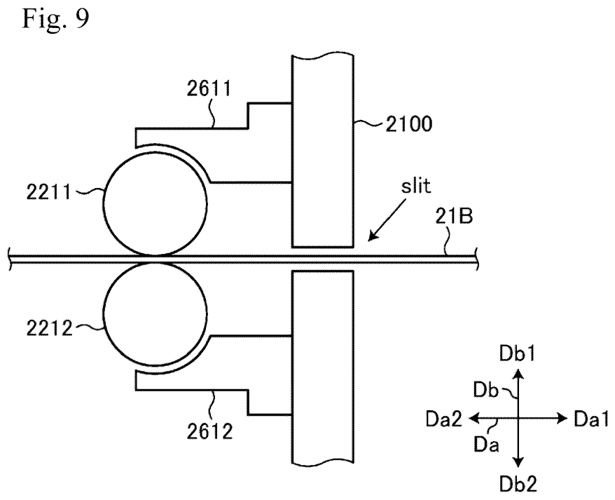

Next, the configuration in the vicinity of the slit provided in the chamber 2100 will be described with reference to FIG. 9. In FIG. 9, the upstream side Da2 of the slit indicates the outside of the chamber 2100 and the downstream side Da1 of the slit indicates the inside of the chamber 2100.

As shown in FIG. 9, a roller 2211 and a roller 2212 are provided near the slit. The rollers 2211 and 2212 rotate to convey the current collector 21B. That is, the conveying device 2200 rotates the rollers 2211 and 2212 provided outside the chamber 2100 while sandwiching the current collector 21B between the rollers. With this configuration, the current collector 21B is conveyed into chamber 2100 through the slit.

Furthermore, the rollers 2211 and 2212, and the members 2611 and 2612 that are provided in the gaps between the rollers 2211, 2212 and the outer surface of chamber 2100 in order to suppress the inflow of air into chamber 2100, are provided near the slits. The members 2611 and 2612 are examples of the first suppression part. That is, the slit of the chamber 2100 are covered by the current collector 21B, the roller 2211, the roller 2212, the member 2611, and the member 2612, such that the inflow of air into the chamber 2100 is suppressed.

Although the rollers 2211 and 2212 are in close contact with current collector 21B, depending on the surface roughness of current collector 21B, air might flow in a gap between the rollers 2211 and 2212 and the current collector 21B. Therefore, instead of the rollers 2211 and 2212, the conveying device 2200 may use rollers whose surfaces are made of an elastic material to convey the current collector 21B.

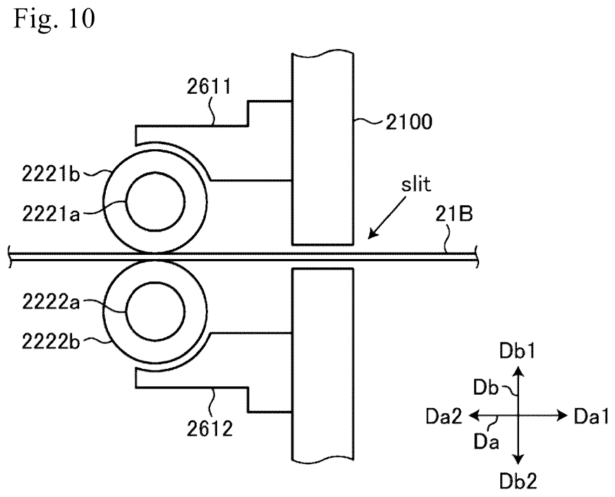

For example, as shown in FIG. 10, the conveying device 2200 may convey the current collector 21B using a roller 2221 constituting a base 2221a and an elastic body 2221b, and a roller 2222 constituting a base 2222a and an elastic body 2222b. The elastic body 2221b and the elastic body 2222b are made of, for example, rubber or elastomer. By forming the side surface of the roller with the elastic body 2221b and the elastic body 2222b, the degree of adhesion with current collector 21B is improved, and the inflow between the rollers and the current collector 21B is suppressed.

Herein, in FIG. 10, an example has been described in which the side surfaces of both of the two rollers that sandwich the current collector 21B are made of an elastic material. However, the embodiment is not limited to this, and the side surface of only one of the two rollers that sandwich the current collector 21B may be made of an elastic material. FIG. 10 shows an example of a method for forming the side surfaces of the rollers with an elastic body, in which the periphery of the base 2221a and the base 2222a are covered with the elastic body 2221b and the elastic body 2222b. However, the embodiment is not limited to this. For example, the entire roller may be made of an elastic material.

As shown in FIG. 9, a gap is provided between the roller 2211 and the member 2611 and between the roller 2212 and the member 2612. Similarly, in FIG. 10, there is a gap between the roller 2221 and the member 2611 and between the roller 2222 and the member 2612. This gap is a clearance for the rollers such as the roller 2211 to rotate. It is conceivable that air may flow into the chamber 2100 through such gaps. As a result, it may be impossible to maintain a sufficiently reduced pressure state of the chamber 2100.

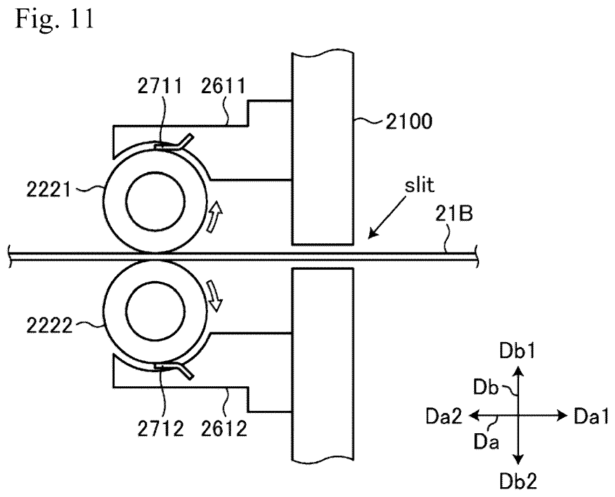

Therefore, the battery electrode manufacturing device 2000 may further include a second suppression part that suppresses the inflow of air from a gap between a roller such as the roller 2211 and the first suppression part of the member 2611. Hereinafter, examples of the second suppression part will be described with reference to FIGS. 11 to 20. In FIGS. 11 to 20, an example will be described in which the rollers 2221 and 2222, the sides of which are made of an elastic material, are provided as rollers for conveying the current collector 21B.

In FIG. 11, valves 2711 and 2712 are shown as an example of the second suppression part. For example, the valve 2711 is attached to the member 2611 and configured to contact the side of roller 2221 that is parallel to the rotation axis. Hereinafter, the side surface of the roller 2221 that is parallel to the rotation axis will also be simply referred to as the side surface of the roller 2221. That is, the valve 2711 is configured to contact the side surfaces of the member 2611 and the roller 2221 and suppresses the inflow of air between the member 2611 and the roller 2221. Similarly, the valve 2712 is configured to contact the sides of the member 2612 and the roller 2222 and suppresses the inflow of air between the member 2612 and the roller 2222.

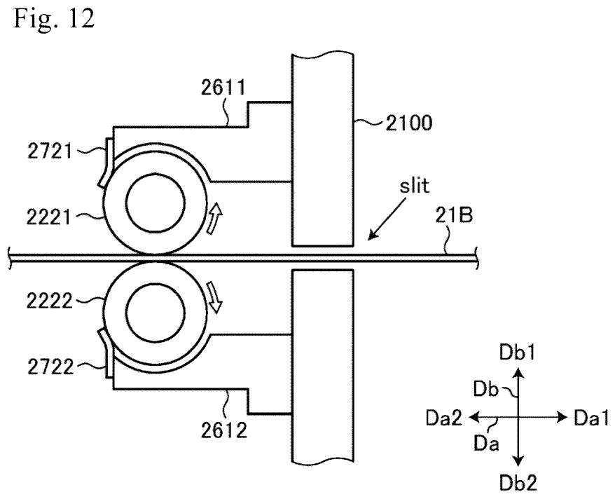

In FIG. 12, valves 2721 and 2722 are shown as an example of the second suppression part. Similar to the valve 2711 in FIG. 11, the valve 2721 is configured to contact the side of the member 2611 and the roller 2221 and prevents air from entering between the member 2611 and the roller 2221. Similar to the valve 2712 in FIG. 11, the valve 2722 is configured to contact the side of the member 2612 and the roller 2222 and prevents air from entering between the member 2612 and the roller 2222.

As shown in FIGS. 11 and 12, the position at which the valve for suppressing the inflow of air is provided is not particularly limited. For example, the valve 2711 in FIG. 11 is mounted within a recess provided in the member 2611 according to the shape of the roller 2221. On the other hand, the valve 2721 shown in FIG. 12 is attached to the upstream side Da2 of the member 2611.

According to the various valves shown in FIGS. 11 and 12, it is possible to maintain a reduced pressure state in the chamber 2100 with a simple configuration. However, since friction occurs between the rollers and the valve, it is conceivable that the rollers such as roller 2221 may become worn.

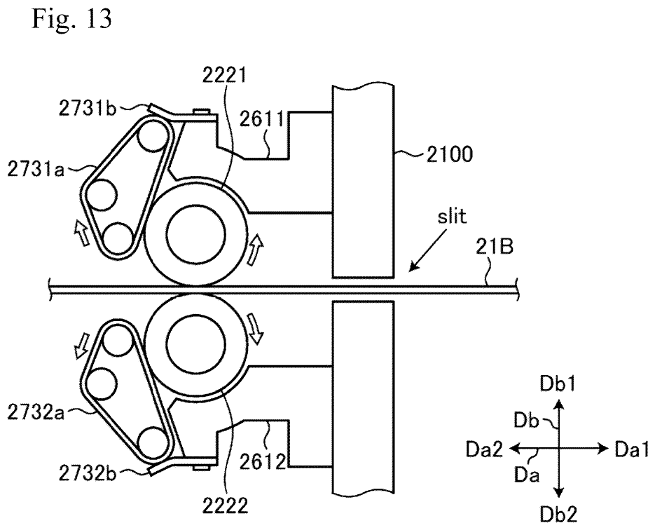

Therefore, the battery electrode manufacturing device 2000 may include a ring-shaped member 2731a that contacts the side surface of the roller 2221 and a ring-shaped member 2732a that contacts the side surface of the roller 2222 as shown in FIG. 13. Herein, the ring-shaped member 2731a rotates while meshing with the rotation of the roller 2221 as shown by the arrow in FIG. 13. In other words, the position of the ring-shaped member 2731a that contacts the roller 2221 and the position of the roller 2221 that contacts the ring-shaped member 2731a are configured to move along the same direction at the same speed. The ring-shaped member 2731a may be driven by a motor or the like (not shown), or may be driven by the roller 2221. Similarly, the ring-shaped member 2732a rotates while meshing with the rotation of the roller 2222.

As shown in FIG. 13, the battery electrode manufacturing device 2000 further comprises a valve 2731b that is in contact with the ring-shaped member 2731a and the member 2611, and a valve 2732b that is in contact with the ring-shaped member 2732a and the member 2612. In FIG. 13, the slit of chamber 2100 is covered by the current collector 21B, the roller 2221, the roller 2222, the ring-shaped member 2731a, the ring-shaped member 2732a, the valve 2731b, the valve 2732b, the member 2611, and the member 2612, thereby preventing air from entering the chamber 2100. Furthermore, in FIG. 13, the valves 2731b and 2732b are not in contact with the rollers 2221 and 2222, avoiding wear on these rollers. The ring-shaped member 2731a, the ring-shaped member 2732a, the valve 2731b, and the valve 2732b are examples of a second suppression part.

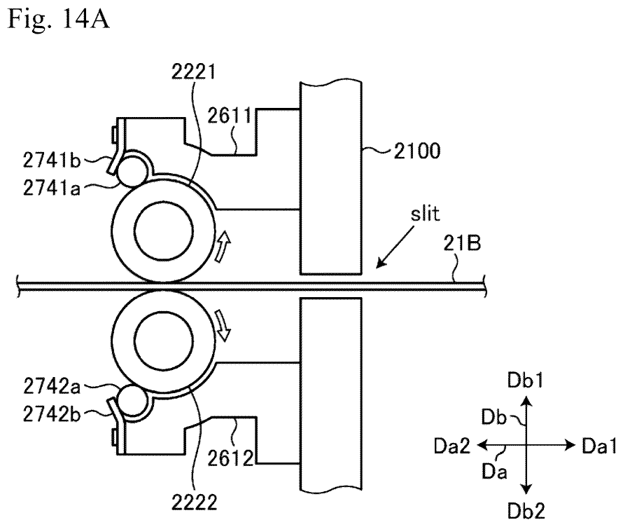

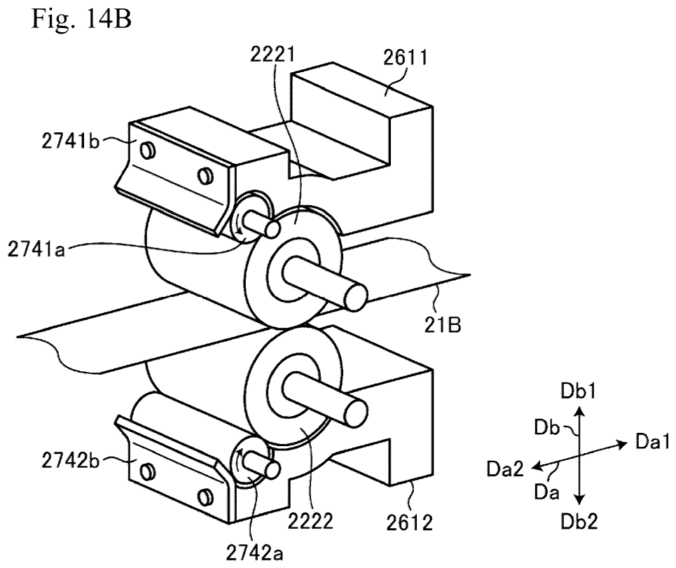

FIGS. 14A and 14B show an example in which an air inflow suppression roller 2741a and an air inflow suppression roller 2742a are provided instead of the ring-shaped member 2731a and the ring-shaped member 2732a. Herein, FIG. 14A is a view seen from the width direction perpendicular to the conveying direction Da and the vertical direction Db, while FIG. 14B is a perspective view.

The air inflow suppression roller 2741a rotates while meshing with the rotation of the roller 2221. The air inflow suppression roller 2741a may be driven by a motor or the like (not shown), or may be driven by the roller 2221. Similarly, the air inflow suppression roller 2742a rotates while meshing with the rotation of the roller 2222. In FIGS. 14A and 14B, the slit of the chamber 2100 is covered by the current collector 21B, the roller 2221, the roller 2222, the air inflow suppression roller 2741a, the air inflow suppression roller 2742a, the valve 2741b, the valve 2742b, the member 2611, and the member 2612. Therefore, the inflow of air into the chamber 2100 is suppressed. Furthermore, in FIGS. 14A and 14B, the valves 2741b and 2742b do not contact the rollers 2221 and 2222, avoiding wear on these rollers. The air inflow suppression roller 2741a, the air inflow suppression roller 2742a, the valve 2741b, and the valve 2742b are examples of the second suppression part.

The various second suppression parts described above can suppress the inflow of air from the side surface that is parallel to the rotation axis in terms of rollers such as roller 2221. Herein, in order to more sufficiently maintain the reduced pressure state in the chamber 2100, it is preferable to also suppress the inflow of air from the bottom surface that is perpendicular to the rotation axis of rollers such as the roller 2221.

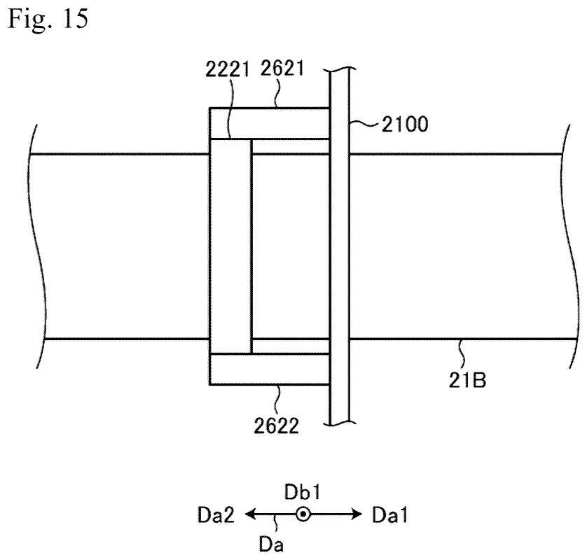

FIG. 15 shows the configuration (rollers 2221, etc.) near the slit from the upper side Db1 along the vertical direction Db. Herein, in FIG. 15, the member 2611 and the various second suppression parts shown in FIGS. 11 to 14B are omitted. As shown in FIG. 15, the battery electrode manufacturing device 2000 comprises the members 621 and 622 that are provided in the gap between the roller 2221 and the outer surface of the chamber 2100, wherein the members 621 and 622 are to suppress the inflow of air into the chamber 2100. The members 621 and 622 are examples of the first suppression part. The members 2611 and 2612 shown in FIGS. 9 to 14B and the members 621 and 622 shown in FIG. 15 may be different members, or may be configured integrally.

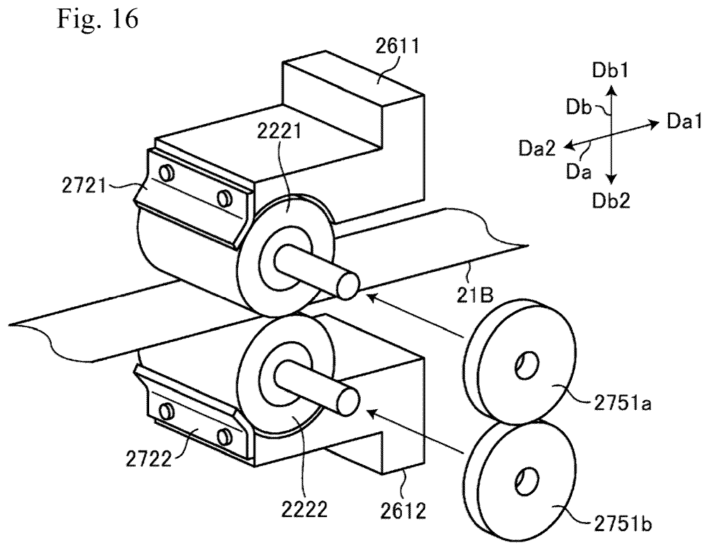

As described below, the battery electrode manufacturing device 2000 may include a bottom surface, which is perpendicular to the rotation axis of a roller such as the roller 2221, and a bottom surface member that is in contact with a first suppression part such as the member 621 as a second suppression part. As examples of such bottom surface members, members 2751a and 2751b are shown in FIG. 16.

As shown in FIG. 16, the member 2751a is a bush that is fitted onto the rotation axis of the roller 2221. The member 2751a fills the gap between the bottom surface of the roller 2221 and the member 622 shown in FIG. 15, and suppresses the inflow of air from the bottom surface of the roller 2221. Similarly, the member 2751b fills the gap between the bottom surface of roller 2222 and member 622, and suppresses the inflow of air from the bottom surface of roller 2222. Even if the members 2751a and 2751b cannot completely block the inflow of air from the bottom surface of roller 2221, the flow of air flowing in from the bottom surface can be made turbulent rather than laminar. Thereby, it is possible to increase the viscous resistance of the air and reduce the amount of inflow.

Although it is not shown in FIG. 16, members similar to the members 2751a and 2751b are fitted into the bottom surfaces on the opposite sides of the rollers 2221 and 2222. The members 2751a and 2751b are made of, for example, felt.

FIG. 16 shows an example in which the member 2751a is fitted onto the rotation axis of the roller 2221, and the member 2751b is fitted onto the rotation axis of the roller 2222. In other words, FIG. 16 shows an example in which members are fitted individually for each roller. However, a single member may be fitted to the rollers 2221 and 2222.

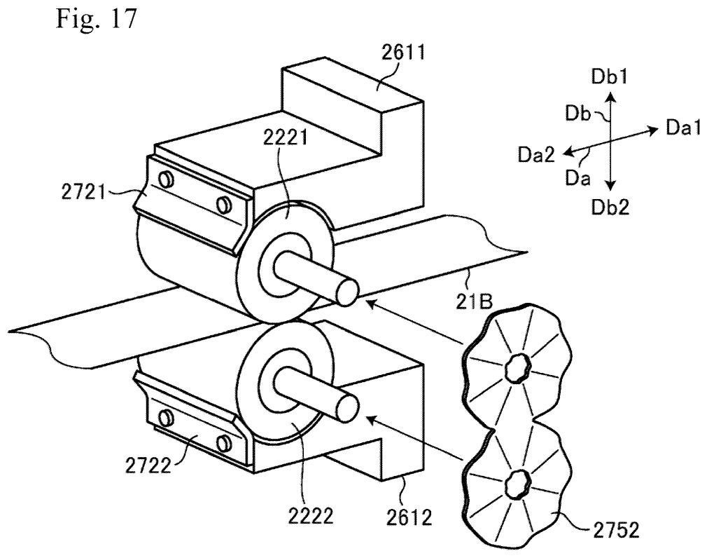

For example, the battery electrode manufacturing device 2000 may have a blade 2752 shown in FIG. 17 instead of the members 2751a and 2751b shown in FIG. 16. That is, the blade 2752 is an example of a bottom surface member. As shown in FIG. 17, the blade 2752 is a corrugated plate having ridges radiating from the axis of rotation of each roller. This makes it possible to fill the gap between the bottom surfaces of the rollers 2221 and 2222 and the member 622, and to suppress the inflow of air. In addition, it is possible to make the contact area between the rollers 2221 and 2222 smaller, and not to impede the rotation of the rollers 2221 and 2222.

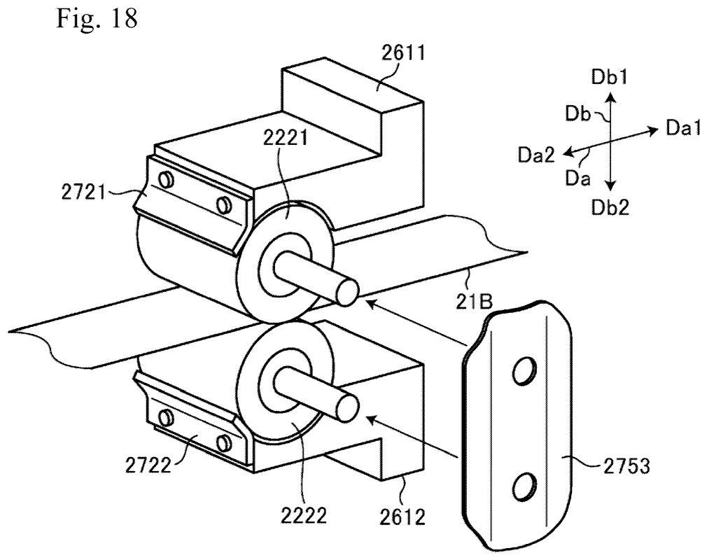

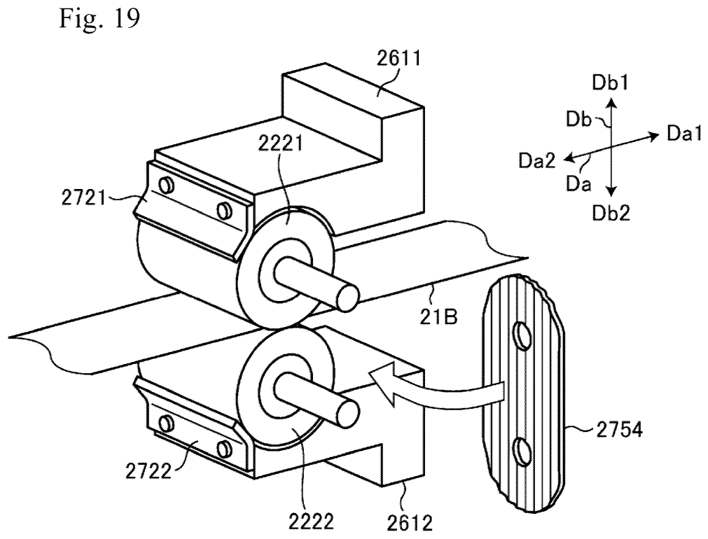

Alternatively, the battery electrode manufacturing device 2000 may have a blade 2753 shown in FIG. 18 as the bottom surface member. The blade 2753 is a corrugated plate having parallel ridges in the vertical direction. Alternatively, the battery electrode manufacturing device 2000 may have a blade 2754 shown in FIG. 19 as the bottom surface member. The blade 2754 is a corrugated plate having many parallel ridges in the vertical direction. Due to the blades 2753 and 2754, it is possible to fill the gap between the bottom surfaces of the rollers 2221 and 2222 and the member 622 and suppress the inflow of air. In addition, it is possible to make the contact area between the rollers 2221 and 2222 smaller, and not to impede the rotation of the rollers 2221 and 2222.

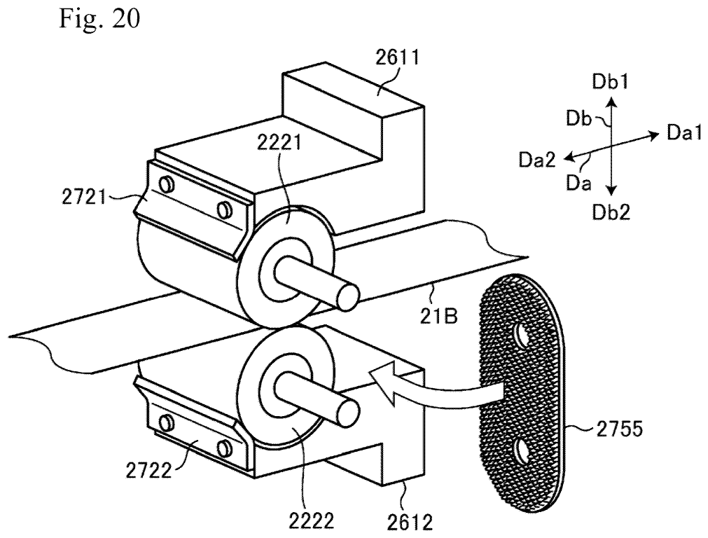

Alternatively, the battery electrode manufacturing device 2000 may have a blade 2755 shown in FIG. 20 as the bottom surface member. The member 2755 has fuzz on the surface that contacts the rollers 2221 and 2222. Due to the fuzz, it is possible to fill the gap between the bottom surfaces of the rollers 2221 and 2222 and the member 622 and suppress the inflow of air. In addition, it is possible to make the contact area between the rollers 2221 and 2222 smaller, and not to impede the rotation of the rollers 2221 and 2222.

Herein, in the second embodiment, only one pair of rollers, such as the roller 2221 and the roller 2222, is shown and described. However, the embodiment is not limited to this, and a plurality of pairs of rollers may be provided. In this case, the above-mentioned first suppression part and second suppression part may be provided for each of the pair of rollers. In other words, in the above-described embodiment, a configuration may be adopted in which a plurality of anterior chambers are provided and the pressure can be reduced gradually in stages.

Furthermore, in the embodiment described above, the strip-shaped base film on which the electrode composition 22c is placed is explained as the strip-shaped current collector 21B. However, it is not limited to this. For example, instead of the strip-shaped current collector 21B shown in FIG. 8, a strip-shaped separator sheet or a strip-shaped release film may be used as the base film. The strip-shaped separator sheet can be later trimmed to form the separator 30 shown in FIG. 1.

For example, in a case when the separator sheet is used as the base film, the electrode composition 22c is supplied onto the separator sheet, and the current collector 21B is supplied onto the surface of electrode composition 22c opposite side from the separator sheet. Then, the separator sheet and the current collector 21B are trimmed to a predetermined shape, and further, the frame member 35 is provided, thereby completing the production of the cathode 20a or the anode 20b.

In addition, in a case when a release film is used as the base film, the electrode composition 22c is supplied onto the release film, the current collector 21B is supplied to the surface of the electrode composition 22c, wherein the surface is opposite from the release film, the release film is collected, and then a separator sheet is supplied to the surface opposite from the current collector 21B. Then, the separator sheet and the current collector 21B are trimmed to a predetermined shape, and further, the frame member 35 is provided, thereby completing the production of the cathode 20a or the anode 20b. Instead of supplying the separator sheet and then trimming it, the separator 30 may be supplied to the electrode composition 22c.

Alternatively, the electrode composition 22c is supplied onto the release film, the separator sheet is supplied to the surface of the electrode composition 22c, wherein the surface is opposite from the release film, the release film is collected, and then the current collector 21B is supplied to the surface opposite from the separator sheet. Then, the separator sheet and the current collector 21B are trimmed to a predetermined shape, and further, the frame member 35 is provided, thereby completing the production of the cathode 20a or the anode 20b. Instead of supplying the current collector 21B and then trimming it, the current collector 21, which has been trimmed to a certain shape, may be supplied to the electrode composition 22c.

Although the embodiments of this invention have been described above in detail with reference to the figures, the specific configuration is not limited to these embodiments. This invention also includes modifications, combinations, deletions, etc. of the configuration without departing from the gist of the present invention. Furthermore, it is needless to say that the configurations shown in each embodiment can be used in appropriate combinations.

What is claimed is:

1. A battery electrode manufacturing device comprising:
a conveying part that conveys a strip-shaped base film;
an electrode composition supply part that supplies an electrode composition, which is wet powder including an active material and an electrolyte solution, to a predetermined supply position along the conveying direction of the base film; and
a width guide part that controls the width of the electrode composition supplied onto the base film at the supply position.

2. The battery electrode manufacturing device according to claim 1,
wherein the width guide part comprising:
members that are in contact with both ends of the electrode composition, which is supplied onto the base film, along the width direction at the supply position; and
a driving device that conveys the members at the same speed as the base film and the electrode composition toward the downstream side along the conveying direction, while the members are in contact with both ends of the electrode composition along the width direction.

3. The battery electrode manufacturing device according to claim 2,
wherein the members are disk-shaped members that rotate around the vertical direction as their rotation axis, and
wherein the driving device rotates the disk-shaped members such that the speed of the positions of the disk-shaped members is the same as the speed of the base film and the electrode composition, while said positions are in contact with the electrode composition.

4. The battery electrode manufacturing device according to claim 2,
wherein the members are ring-shaped members that rotate around the vertical direction as their rotation axis, and
wherein the driving device rotates the ring-shaped members such that the speed of the positions of the ring-shaped members is the same as the speed of the base film and the electrode composition, while said positions are in contact with the electrode composition.

5. The battery electrode manufacturing device according to claim 2,
wherein the members are ring-shaped members that rotate around the width direction as their rotation axis, and
wherein the driving device rotates the ring-shaped members such that the speed of the positions of the ring-shaped members is the same as the speed of the base film and the electrode composition, while said positions are in contact with the electrode composition.

6. The battery electrode manufacturing device according to claim 1,
wherein the width guide part is a member that is fixed at the supply position, and that is in contact with both ends of the electrode composition, which is supplied onto the base film, along the width direction.

7. The battery electrode manufacturing device according to claim 1, further comprising:
a chamber whose interior is decompressed below atmospheric pressure;
a first suppression part; and
a second suppression part,
wherein the conveying part conveys the base film into the chamber through a slit, which is provided in the chamber, by rotating two rollers while sandwiching the base film between the two rollers provided outside the chamber,
wherein the first suppression part is provided in a gap between the roller and an outer surface of the chamber, and suppresses the inflow of air into the chamber, and
wherein the second suppression part is provided in a gap between the roller and the first suppression part, and suppresses the inflow of air into the chamber.

8. The battery electrode manufacturing device according to claim 7,
wherein the second suppression part includes the side surface that is parallel to the rotation axis of the roller and a valve that is in contact with the first suppression part.

9. The battery electrode manufacturing device according to claim 7,
wherein the second suppression part includes a ring-shaped member that is in contact with the side surface that is parallel to the rotation axis of the roller and that rotates while meshing with the rotation of the roller, and a valve that is in contact with the ring-shaped member and the first suppression part.

10. The battery electrode manufacturing device according to claim 7,
wherein the second suppression part includes an air inflow suppression roller that is in contact with the side surface that is parallel to the rotation axis of the roller and that rotates while meshing with the rotation of the roller, and a valve that is in contact with the air inflow suppression roller and the first suppression part.

11. The battery electrode manufacturing device according to claim 7,
wherein the second suppression part includes a bottom surface, which is perpendicular to the rotation axis of the roller, and a bottom surface member that is in contact with the first suppression part.

12. The battery electrode manufacturing device according to claim 11,
wherein the bottom surface member is one of the members including a bush fitted onto the rotation axis of the roller, a member constituting felt, a corrugated blade with ridges that radiate from the rotation axis of the roller, a corrugated blade with vertically parallel ridges, or a fuzz that is in contact with the roller.

13. The battery electrode manufacturing device according to claim 7,
wherein at least one of the two rollers has a side surface that is parallel to the rotation axis of the roller, and that is made of an elastic material.

14. A battery electrode manufacturing method including:
a step of supplying an electrode composition, which is wet powder including an active material and an electrolyte solution, to a predetermined supply position along the conveying direction of a strip-shaped base film that is conveyed; and
a step of controlling the width of the electrode composition at the supply position, wherein the electrode composition is supplied onto the base film.

15. The battery electrode manufacturing method according to claim 14, further including:
a step of conveying the base film into a chamber through a slit, which is provided in the chamber, by rotating two rollers while sandwiching the base film between the two rollers provided outside the chamber,
a step of suppressing the inflow of air into the chamber by a first suppression part that is provided in a gap between the roller and an outer surface of the chamber, and
a step of suppressing the inflow of air into the chamber by a second suppression part that is provided in a gap between the roller and the first suppression part.
